(19) United States
(12) Patent Application Publication
(10) Pub. No.: US 2018/0085194 A1
(43) Pub. Date: Mar. 29, 2018

(54) CARTRIDGE FOR TREATING DENTAL ROOT AND METHOD FOR MANUFACTURING NEEDLE FOR TREATING DENTAL ROOT

(71) Applicant: Eunseok YUN, Chalfont, PA (US)

(72) Inventor: Eunseok YUN, Chalfont, PA (US)

(21) Appl. No.: 15/276,513

(22) Filed: Sep. 26, 2016

(51) Int. Cl. A61C 5/04; A61C 5/02

(52) U.S. Cl. CPC A61C 5/04; A61C 5/02

(57) ABSTRACT

Provided is a cartridge for treating a dental root including: a cap storing a treatment material therein; a needle arranged at an end of the cap to transfer the treatment material stored in the cap to the dental root; and a handle mounted on the outer circumferential surface of the cap to combine the cap to a device for treating the dental root, wherein the cap has a retaining jaw formed on a portion, to which the handle is fit, along the circumferential surface, and the handle has a rotation support hole for inserting the cap into the handle and a plurality of spilt pieces formed at a smaller-diameter outlet of the rotation support hole to push and pressurize the retaining jaw.

### BACKGROUND

The present invention relates to a cartridge for treating a dental root and a method for manufacturing a needle for treating a dental root, and more particularly, to a cartridge for treating a dental root which allows an operator to rapidly adjust a position of a needle according to a surgical site when the cartridge adopting the needle is combined to a device for treating the dental root, and a method for manufacturing a needle for treating a dental root which can easily manufacture the needle adopted to the cartridge for treating the dental root.

In general, various methods for treating teeth have been proposed and disclosed, and one of them is the endodontic treatment to make a tooth function in place without extraction of the tooth if possible.

The endodontic treatment includes the process of treating the dental root. In order to treat the dental root, a cartridge for treating a dental root is combined to a device for treating a dental root to be used.

The conventional cartridge for treating a dental root is very uncomfortable because it has to be separated from the device and be reassembled to the device in order to adjust a position of a needle according to a surgical site during treatment of the dental root.

### SUMMARY OF THE INVENTION

Accordingly, the present invention has been made in view of the above-mentioned problems occurring in the prior art, and it is an object of the present invention to provide a cartridge for treating a dental root which allows an operator to rapidly adjust a position of a needle according to a surgical site when the cartridge adopting the needle is combined to a device for treating the dental root.

It is another object of the present invention to provide a method for manufacturing a needle for treating a dental root adopted to the cartridge for treating a dental root.

To accomplish the above object, according to the present invention, there is provided a cartridge for treating a dental root including: a cap storing a treatment material therein; a needle arranged at an end of the cap to transfer the treatment material stored in the cap to the dental root; and a handle mounted on the outer circumferential surface of the cap to combine the cap to a device for treating the dental root, wherein the cap has a retaining jaw formed on a portion, to which the handle is fit, along the circumferential surface, and the handle has a rotation support hole for inserting the cap into the handle and a plurality of spilt pieces formed at a smaller-diameter outlet of the rotation support hole to push and pressurize the retaining jaw.

In the cartridge for treating the dental root according to an embodiment of the present invention, the needle includes: a body part; a first reduced part which is formed integrally with the body part and has an inner diameter smaller than that of the body part; and a second reduced part which is formed integrally with the first reduced part and has an inner diameter smaller than that of the first reduced part. The needle is made of copper.

In the cartridge for treating the dental root according to an embodiment of the present invention, a tapered part whose diameter is gradually reduced from a first boundary between the body part and the first reduced part toward a second boundary between the first reduced part and the second reduced part is formed on the outer circumferential surface of the first reduced part, and another tapered part whose diameter is gradually reduced from the second boundary between the first reduced part and the second reduced part toward an end of the second reduced part is formed on the outer circumferential surface of the second reduced part.

In the cartridge for treating the dental root according to an embodiment of the present invention, the needle is the thinnest at the first boundary between the body part and the first reduced part.

In the cartridge for treating the dental root according to an embodiment of the present invention, the needle is the thinnest at the second boundary between the first reduced part and the second reduced part.

In another aspect of the present invention, the present invention provides a method for manufacturing a needle for treating a dental root including the steps of: preparing a copper pipe which is 1.00 mm in outer diameter and 0.60 mm in inner diameter; cutting the outer diameter of the copper pipe to become an outer diameter of 0.84 mm in a 3 mm zone inwards from the right end of the copper pipe; rotating the copper pipe and inserting the zone of the copper pipe, which has the outer diameter of 0.84 mm, into a shaft tube jig having a diameter of 0.75 mm, so that a first reduced part which is 0.75 mm in outer diameter and 0.50 mm in inner diameter is formed; cutting the outer diameter of the copper pipe to become an outer diameter of 0.65 mm in a 1 mm zone inwards from the right end of the copper pipe; and rotating the copper pipe and inserting the zone of the copper pipe, which has the outer diameter of 0.65 mm, into a shaft tube jig having a diameter of 0.60 mm, so that a second reduced part which is 0.60 mm in outer diameter and 0.38 mm in inner diameter is formed.

The method for manufacturing the needle according to an embodiment of the present invention further includes the step of forming a tapered part, whose diameter is gradually reduced from a start point of the first reduced part toward a second boundary between the first reduced part and the second reduced part, on the outer circumferential surface of the first reduced part, and forming another tapered part, whose diameter is gradually reduced from the second boundary between the first reduced part and the second reduced part toward an end of the second reduced part, on the outer circumferential surface of the second reduced part.

In the method for manufacturing the needle, the needle is the thinnest at the start point of the first reduced part.

In the method for manufacturing the needle, the needle is the thinnest at the second boundary between the first reduced part and the second reduced part.

The cartridge for treating a dental root according to embodiments of the present invention has the following effects.

First, the cartridge for treating a dental root can accurately control a rotational angle of the needle because the cap is combined to the handle in a concavo-convex form so that the cap can rotate at a predetermined angle.

Second, the cartridge for treating a dental root can rapidly adjust the position of the needle when the operator rotates the cap according to a surgical site.

Third, because the adopted needle is the thinnest at the boundary between the body part and the first reduced part or at the boundary between the first reduced part and the second reduced part, if the needle is stopped by an external factor, the boundary between the body part and the first reduced part or the boundary between the first reduced part and the second reduced part is destroyed. Therefore, the cartridge for treating a dental root can effectively control pollution of the device for treating the dental root.

Moreover, the method for manufacturing the needle for treating a dental root according to an embodiment of the present invention allows a worker to easily manufacture the needle adopted to the cartridge for treating a dental root.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a cartridge for treating a dental root according to a preferred embodiment of the present invention;

FIG. 2 is an enlarged sectional view of the cartridge for treating the dental root according to the preferred embodiment of the present invention;

FIG. 3 is a sectional view of a needle adopted for the cartridge for treating the dental root according to the preferred embodiment of the present invention; and

FIGS. 4a to 4e are sectional views showing processes of a method for manufacturing a needle of FIG. 3.

### DETAILED DESCRIPTION OF THE PREFERRED EMBODIMENT

Specific matters of other embodiments are included in the detailed description and drawings of the present invention.

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are given to provide complete disclosure of the invention and thorough understanding of the present invention to those skilled in the art. The scope of the present invention is defined only by the claims. Like reference numerals indicate like elements throughout the specification and drawings.

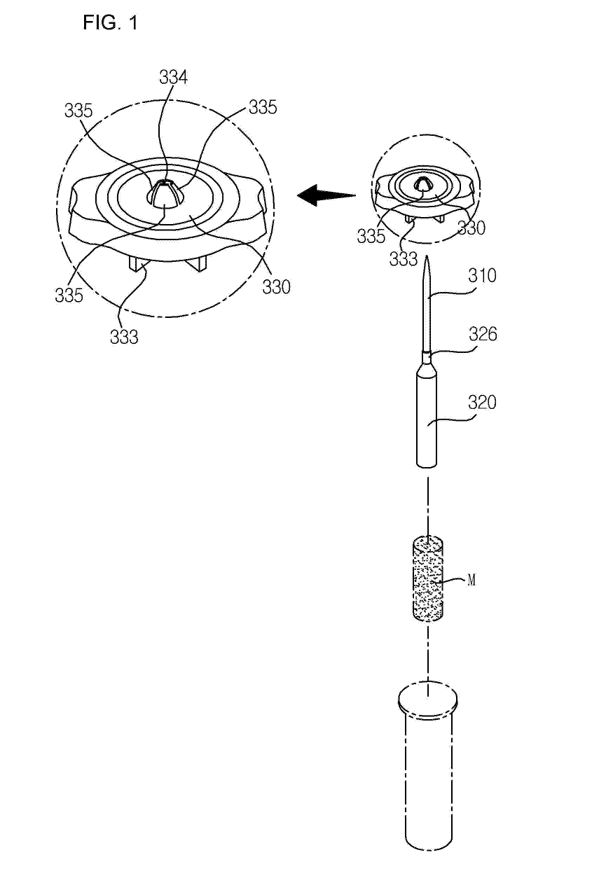

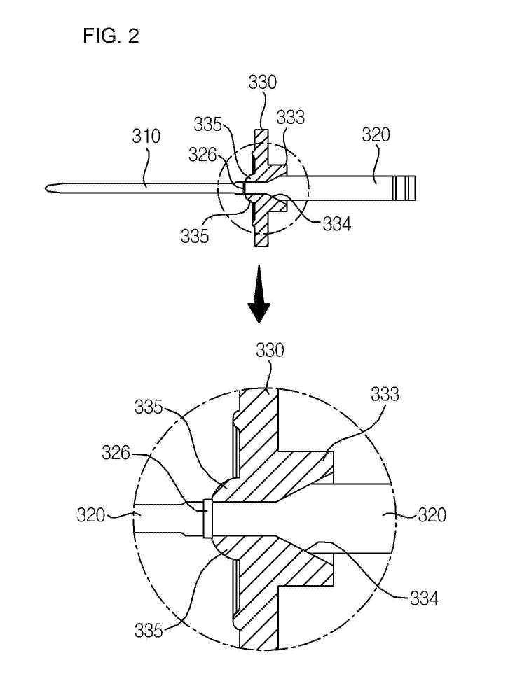

As illustrated in FIGS. 1 and 2, a cartridge for treating a dental root according to a preferred embodiment of the present invention includes a cap 320, a needle 310 and a handle 330.

The cap 320 stores a treatment material (M) therein, and the needle 310 is arranged at one end of the cap 320 to transfer the treatment material (M) stored in the cap 320 to a dental root. The handle 330 is mounted on the outer circumferential surface of the cap 320 to combine the cap 320 to a device for treating the dental root.

Here, the handle 330 includes: a rotation support hole 334 to be fit to the cap 320; and a plurality of split pieces 335 formed at a smaller-diameter outlet of the rotation support hole 334 to push and pressurize a retaining jaw 326.

Hereinafter, the cartridge for treating the dental root will be described in more detail.

The needle 310 is arranged at one end of the cap 320, and the handle 330 is rotatably mounted on the outer circumferential surface of the cap 320. As described above, the cap 320 has the treatment material (M) stored therein, and the cartridge for treating the dental root is inserted and mounted into the device for treating the dental root. In this instance, the treatment material (M) goes into the device for treating the dental root and one side of the handle 330 comes into contact with the device for treating the dental root. When an operator rotates the handle 330 with his or her hand, a stopper 333 arranged on the bottom of the handle 330 is fixed and mounted to the device for treating the dental root.

In the meantime, the cap 320 has the retaining jaw 326. The retaining jaw 326 is formed in a round band type along the outer circumferential surface of the cap 320 so that the split pieces 335 can get in contact with the retaining jaw 326.

The handle 330 has the rotation support hole 334 formed in one side. In this instance, due to the rotation support hole 334, the handle 330 comes into close contact with the cap 320 when the cap 320 is inserted into the handle 330, so that the handle 330 does not fall out.

Furthermore, the rotation support hole 334 has a plurality of the split pieces 335 formed at the rim of the outlet, namely, a smaller diameter part. The split pieces 335 are transformed while going over the retaining jaw 326 when the cap 320 is inserted into the rotation support hole 334, and then, perfectly pressurizes the retaining jaw 326 after being transformed.

The split pieces 335 mounted as described above is caught to the retaining jaw 326 so as to prevent the handle 330 from falling out of the cap 320, and pressurizes the retaining jaw 326 so as to provide frictional force to rotate the needle 310 together with the cap 320 when the operator rotates the needle with a predetermined power.

Hereinafter, the needle 310 will be described in more detail.

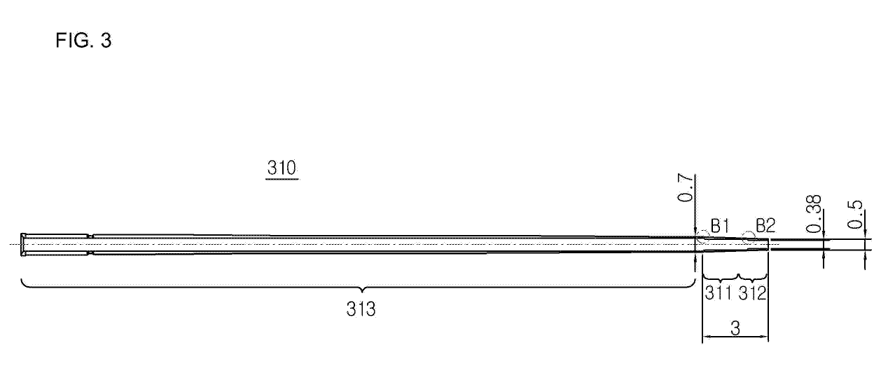

As illustrated in FIG. 3, the needle 310 is formed integrally with a body part 313, and includes: a first reduced part 311 which has an inner diameter smaller than that of the body part 31 3; and a second reduced part 312 which has an inner diameter smaller than that of the first reduced part 311.

Here, a tapered part whose diameter is gradually reduced from a first boundary B1 between the body part 313 and the first reduced part 311 toward a second boundary B2 between the first reduced part 311 and the second reduced part 312 is formed on the outer circumferential surface of the first reduced part 311. Another tapered part whose diameter is gradually reduced from the second boundary B2 between the first reduced part 311 and the second reduced part 312 toward an end of the second reduced part 312 is formed on the outer circumferential surface of the second reduced part 312.

Meanwhile, the needle 310 is the thinnest at the first boundary B1 between the body part 313 and the first reduced part 311 or at the second boundary B2 between the first reduced part 311 and the second reduced part 312.

Hereinafter, a method for manufacturing the needle 310 will be described.

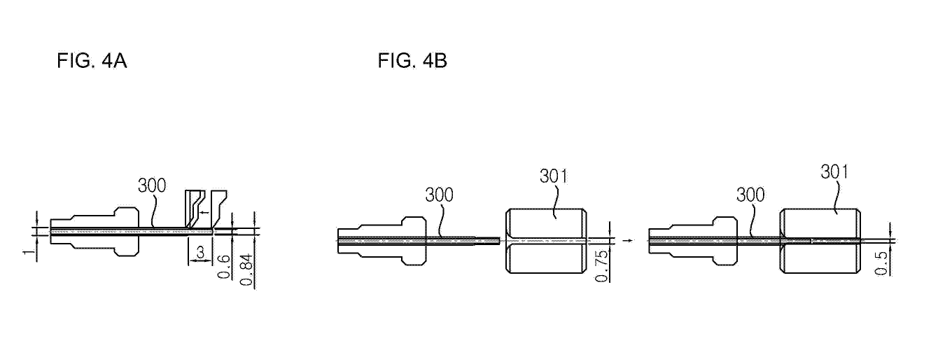

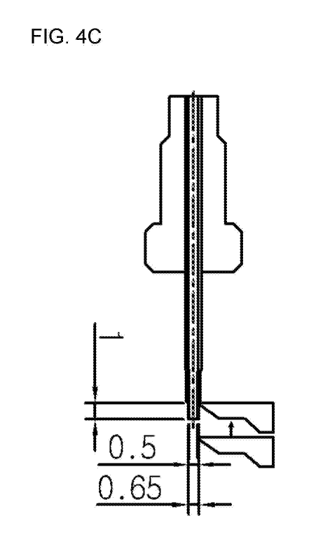

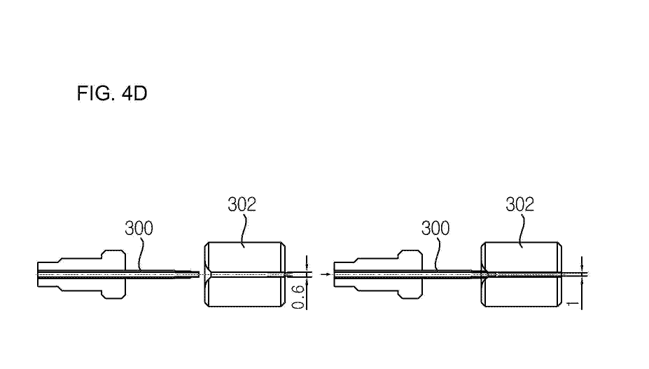

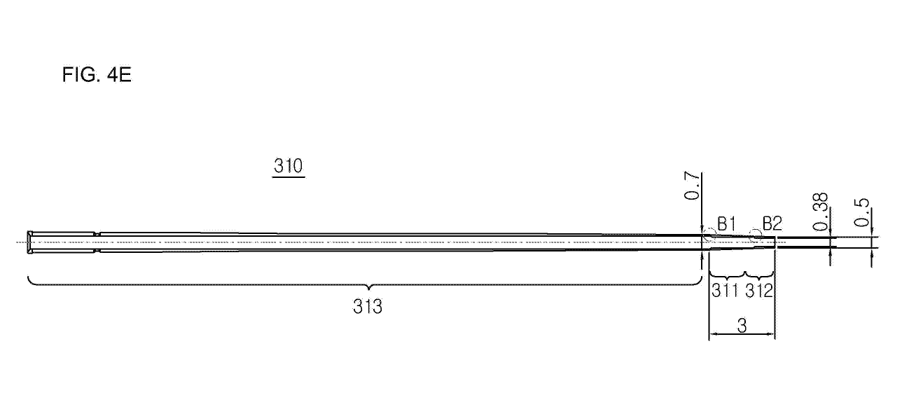

First, as illustrated in FIG. 4a, prepare a copper pipe 300 is 1.00 mm in outer diameter and 0.60 mm in inner diameter.

Next, as illustrated in FIG. 4a, cut the outer diameter of the copper pipe 300 to become an outer diameter of 0.84 mm in a 3 mm zone inwards from the right end of the copper pipe 300.

Next, as illustrated in FIG. 4b, rotate the copper pipe 300 and insert the zone of the copper pipe 300, which has the outer diameter of 0.84 mm, into a shaft tube jig 301 having a diameter of 0.75 mm, so that the first reduced part which is 0.75 mm in outer diameter and 0.50 mm in inner diameter is formed.

Next, as illustrated in FIG. 4c, cut the outer diameter of the copper pipe 300 to become an outer diameter of 0.65 mm in a 1 mm zone inwards from the right end of the copper pipe 300.

Next, as illustrated in FIG. 4d, rotate the copper pipe 300 and insert the zone of the copper pipe 300, which has the outer diameter of 0.65 mm, into a shaft tube jig 302 having a diameter of 0.60 mm, so that the second reduced part which is 0.60 mm in outer diameter and 0.38 mm in inner diameter is formed.

Next, as illustrated in FIG. 4e, the tapered part whose diameter is gradually reduced from the start point B1 of the first reduced part 311 toward the second boundary B2 between the first reduced part 311 and the second reduced part 312 is formed on the outer circumferential surface of the first reduced part 311, and the other tapered part whose diameter is gradually reduced from the second boundary B2 between the first reduced part 311 and the second reduced part 312 toward the end of the second reduced part 312 is formed on the outer circumferential surface of the second reduced part 312.

Here, as illustrated in FIG. 4e, the needle 310 is the thinnest at the start point B1 of the first reduced part 311 or at the second boundary B2 between the first reduced part 311 and the second reduced part 312. In detail, the needle 310 at the start point B1 of the first reduced part 311 or the needle 310 at the second boundary B2 between the first reduced part 311 and the second reduced part 312 is about 0.05 mm in thickness.

Those skilled in the art will understand that the present invention can be implemented as other concrete forms without changing the inventive concept or essential features. Therefore, these embodiments as described above are only proposed for illustrative purposes and do not limit the present invention.

It will be apparent to those skilled in the art that a variety of modifications and variations may be made without departing the spirit and scope of the present invention as defined by the appended claims. Further, such modifications and variations should not be understood independently from the technical idea or perspective of the present invention.

What is claimed is:

1. A cartridge for treating a dental root comprising:
a cap storing a treatment material therein;
a needle arranged at an end of the cap to transfer the treatment material stored in the cap to the dental root; and
a handle mounted on the outer circumferential surface of the cap to combine the cap to a device for treating the dental root,
wherein the cap has a retaining jaw formed on a portion, to which the handle is fit, along the circumferential surface, and
wherein the handle has a rotation support hole for inserting the cap into the handle and a plurality of spilt pieces formed at a smaller-diameter outlet of the rotation support hole to push and pressurize the retaining jaw.

2. The cartridge according to claim 1, wherein the needle comprises:
a body part;
a first reduced part which is formed integrally with the body part and has an inner diameter smaller than that of the body part; and
a second reduced part which is formed integrally with the first reduced part and has an inner diameter smaller than that of the first reduced part, and
wherein the needle is made of copper.

3. The cartridge according to claim 2, wherein a tapered part whose diameter is gradually reduced from a first boundary between the body part and the first reduced part toward a second boundary between the first reduced part and the second reduced part is formed on the outer circumferential surface of the first reduced part, and another tapered part whose diameter is gradually reduced from the second boundary between the first reduced part and the second reduced part toward an end of the second reduced part is formed on the outer circumferential surface of the second reduced part.

4. The cartridge according to claim 3, wherein the needle is the thinnest at the first boundary between the body part and the first reduced part.

5. The cartridge according to claim 3, wherein the needle is the thinnest at the second boundary between the first reduced part and the second reduced part.

6. A method for manufacturing a needle for treating a dental root comprising the steps of:
preparing a copper pipe which is 1.00 mm in outer diameter and 0.60 mm in inner diameter;
cutting the outer diameter of the copper pipe to become an outer diameter of 0.84 mm in a 3 mm zone inwards from the right end of the copper pipe;
rotating the copper pipe and inserting the zone of the copper pipe, which has the outer diameter of 0.84 mm, into a shaft tube jig having a diameter of 0.75 mm, so that a first reduced part which is 0.75 mm in outer diameter and 0.50 mm in inner diameter is formed;
cutting the outer diameter of the copper pipe to become an outer diameter of 0.65 mm in a 1 mm zone inwards from the right end of the copper pipe; and
rotating the copper pipe and inserting the zone of the copper pipe, which has the outer diameter of 0.65 mm, into a shaft tube jig having a diameter of 0.60 mm, so that a second reduced part which is 0.60 mm in outer diameter and 0.38 mm in inner diameter is formed.

7. The method for manufacturing the needle according to claim 6, further comprising the step of:
forming a tapered part, whose diameter is gradually reduced from a start point of the first reduced part toward a second boundary between the first reduced part and the second reduced part, on the outer circumferential surface of the first reduced part, and forming another tapered part, whose diameter is gradually reduced from the second boundary between the first reduced part and the second reduced part toward an end of the second reduced part, on the outer circumferential surface of the second reduced part.

8. The method for manufacturing the needle according to claim 6, wherein the needle is the thinnest at the start point of the first reduced part.

9. The method for manufacturing the needle according to claim 6, wherein the needle is the thinnest at the second boundary between the first reduced part and the second reduced part.
